(19) United States
(12) Patent Application Publication
(10) Pub. No.: US 2003/0125927 A1
(43) Pub. Date: Jul. 3, 2003

(54) Method and system for translating instant messages

(75) Inventor: Yonas D. Seme, Redmond, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/035,085

(22) Filed: Dec. 28, 2001

(51) Int. Cl. G06F 17/28

(52) U.S. Cl. 704/3

(57) ABSTRACT

A method and system translating instant messages between users who communicate in different languages is presented. Two or more users engaged in an instant messaging session compose messages according to a source language or destination language. The source language corresponds to the preferred language of the user of the device that sends messages during the session, while the destination language corresponds to the preferred language of the user of a device that receives sent messages. During the session, devices can exchange user profile information that specify one or more translation preferences, including the destination address(es), source address(es), and corresponding source and destination languages. A content translation module implemented as a computer-executable module (e.g., DLL, exe) utilizes the information contained in the user profile to translate messages from the source language to the destination language. The translated message is then transmitted to the destination device. Because the message is translated prior to delivery, the destination device receives the message according to the destination language.

### TECHNICAL FIELD

This invention relates generally to real-time communication over a network, and more particularly, relates to methods and systems for translating instant messages exchanged over a network between one or more computing devices.

### BACKGROUND OF THE INVENTION

Instant messaging has become a widely used tool for communicating in realtime over the Internet. Millions of Internet users are using instant messaging applications to chat with friends and family, communicate in chat rooms, and even exchange pictures or documents. Moreover, several organizations and businesses are integrating instant messaging applications into their repertoire of standard network tools to enhance business communication and replace costly telecommunication services (e.g., telephone, video conferencing). As the Internet's popularity continues to increase around the world, it is increasingly likely that communication will cross national boundaries, and that, as a result, users will encounter language barriers when using instant messaging.

There are several systems currently available for addressing such language barriers. In one system, a user of an instant messaging tool types a message in their source language, preferred language, or into a text field, then “cuts and pastes” the text into a separate translation program. The user must then activate the translation tool to translate the message into the destination language, and cut and paste the translated text back into the text field of the instant messaging tool. Once this is complete, the user can transmit the message. While this method can be effective, it is obvious that the process of continually cutting, pasting and switching between applications significantly impedes the communication process. Even in systems where entries typed into the messaging tool are converted “on-the-fly”, such as by activating a “Translate” button that links the instant messaging program to a translation tool; the extra steps required by the user compromise the real-time communication experience.

In other systems, remote servers perform the translation. For example, a client device can send an entire message to a server equipped with translation software. The server then translates the message and sends it back to the client device in translated form. The user of the client device then transmits the message in its translated form to the intended destination device. While this form of messaging translation can be effective, the time required to perform this process makes this implementation impractical for “real-time” (instant) communication. This is because the procedure requires more processing and network resources to be expended, and also introduces extra hops between the client and destination device. Moreover, such systems limit the ability for a user to send messages to multiple users of different languages simultaneously. For instance, an English-speaking user wishing to send the same message to both a Russian-speaking user and Chinese-speaking user in real-time would have to perform the above-described translation process twice. Consequently, the real-time communication experience is negatively impacted as more work is required of the user.

### SUMMARY OF THE INVENTION

The invention relates to a method and system for providing real-time communication over a network between users of different languages. More specifically, the invention relates to a system for instantly translating real-time messages such that multilingual communication is achieved between one or more computing devices without compromising the real-time user experience.

In various embodiments of the invention, a content translation module resides on a source device, destination device, or both. Device implementations include desktop computers, laptops, PDA's or any other computing devices capable of executing an instant messaging application (e.g., MSN Messenger) and facilitating an instant messaging session. The content translation module is implemented as a computer-executable module (e.g., DLL, exe), and contains instructions for translating messages from a language familiar to the user of the source device (source language), to a language familiar to a user of the destination device (destination language). During the session, a user profile may be exchanged by each of the devices. The user profile specifies the preferred settings of each user, such as the source language, the destination language, and the settings of users involved in the session. When the user of the source device composes a message according to the source language, the content translation module detects this language, and translates it into the destination language. In this way, the message received by the user of the destination device conforms to the destination language as opposed to the source language that the message was originally composed in.

In accordance with another embodiment of the invention, the content translation module resides on one or more computers that are along a communication path between the source and destination device. Requests to translate a message composed in a source language to a destination language are received by the content translation module from an instant messaging application operating on the source device. The requests are sent using packets conforming to a common Internet protocol, such as Hypertext Transfer Protocol (HTTP) GET or POST packets (event 304). The packets include the original message as composed in the source language, and translation preference information such as the destination language the message is to be translated into. When the content translation module receives the message, it translates it into the destination language, and subsequently forwards the message to the destination device. Because the message is translated prior to delivery, the destination device receives the message according to the destination language.

Additional features and advantages of the invention will be made apparent from the following detailed description of illustrative embodiments that proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is an example of a computer network;

FIG. 2 is an example of a computer;

FIG. 3 shows a user profile established by a device for enabling real-time communication in accordance with an embodiment of the invention;

FIG. 4 illustrates a real-time communication session between two devices in accordance with an embodiment of the invention;

FIGS. 5a-5b illustrates a real-time communication session between two devices in accordance with an embodiment of the invention;

FIG. 6 is a flowchart showing steps executed in an embodiment of the invention to communicate in real-time as illustrated in FIG. 4; and

FIG. 7 is a flowchart showing steps executed in an embodiment of the invention to communicate in real-time as illustrated in FIGS. 5a and 5b.

### DETAILED DESCRIPTION OF THE INVENTION

The invention relates to a method and system for translating instant messages between users who speak different languages. The invention allows the translation to occur in such a way that multilingual communication is achieved without compromising the real-time user experience. In the context of this invention, multilingual communication refers to communication over a network between computer users of varying ethnicities, cultures, geographic locations, and languages. The invention may be used in conjunction with various software tools and real-time communication services including e-mail utilities, instant messaging applications, voice-over-IP (VOIP) applications, and the like. While instant messaging applications are commonly used for providing real-time communication, those skilled in the art will recognize that the invention is applicable to any type of real-time data exchange.

Also, as used herein, “real-time” communication refers to a session established between one or more devices in which information is instantly sent and received. In instant messaging applications such as MSN Instant Messenger or ICQ, these sessions are executed according to network protocols designed to enhance and support instant messaging. Such protocols include, but are not limited to the Common Profile for Instant Messaging (CPIM) Protocol, the Presence and Instant Messaging Protocol (PRIM), the Application Exchange Core (APEX), and the ICQ (“I seek you”) Protocol. All of these protocols provide data delivery and transport mechanisms for instantly exchanging information between computing devices. The invention is not limited to any one protocol or network implementation, as any architecture by which real-time information exchange can be facilitated is within the scope of the invention.

In the context of a networked environment, general reference will also be made to real-time communication between a “source” device and a “destination” device. The term device includes any type of computing apparatus, such as a PC, laptop, handheld device, or server that is capable of sending and receiving messages over a network according to a standard network protocol. Source devices refer to the device that initiates the communication, or that first composes and sends a message, while destination devices refer to the device that receives the message. Those skilled in the art will recognize that the operation of the source device and destination device are interchangeable. Thus, a destination device may at some point during a session act as a sender of messages, and a source device can at times act as the recipient of messages. For this reason, the systems and methods of the invention may be embodied in traditional source devices as well as destination devices, regardless of their respective hardware, software or network configurations. Indeed, the systems and methods of the invention may be practiced in a variety of environments that require or desire the performance enhancements provided by the invention. These enhancements are set forth in greater detail in subsequent paragraphs.

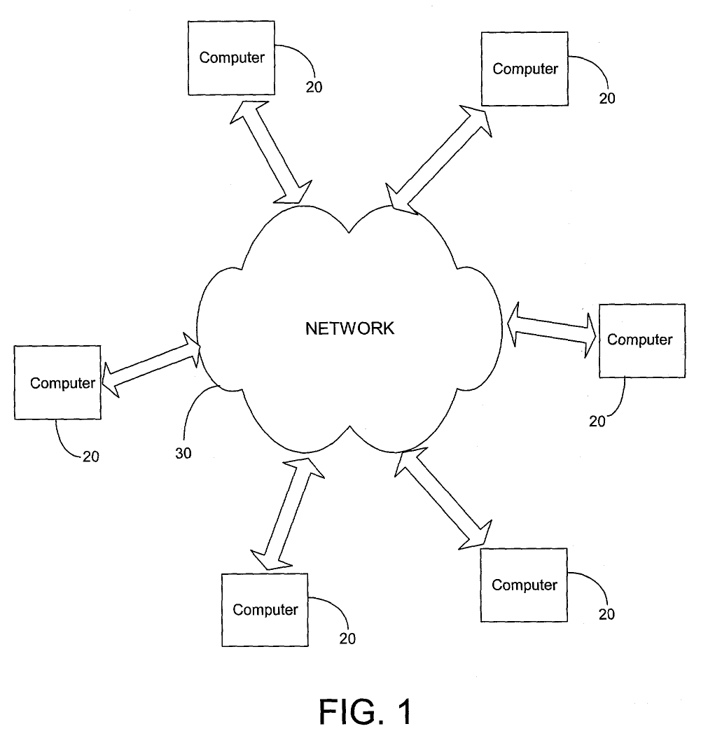

An example of a networked environment in which the invention may be used will now be described with reference to FIG. 1. The example network includes several computers 20 communicating with one another over a network 30, such as the Internet, as represented by a cloud. Network 30 may include many well-known components, such as routers, gateways, hubs, etc. and may allow the computers 20 to communicate via wired and/or wireless media.

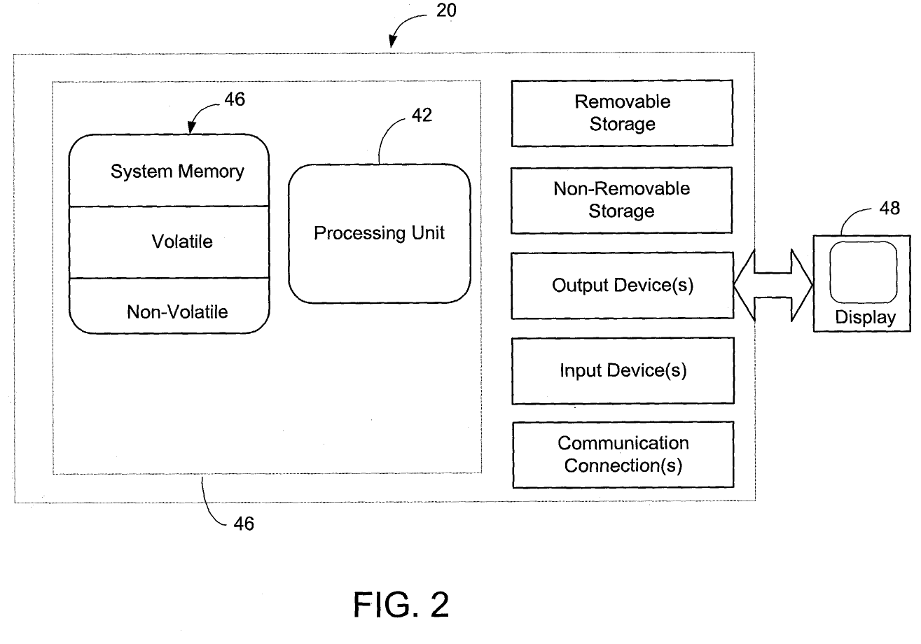

Referring to FIG. 2, an example of a basic configuration for a computer on which the system described herein may be implemented is shown. In its most basic configuration, the computer 20 typically includes at least one processing unit 42 and memory 44. Depending on the exact configuration and type of the computer 20, the memory 44 may be volatile (such as RAM), non-volatile (such as ROM or flash memory) or some combination of the two. This most basic configuration is illustrated in FIG. 2 by dashed line 46. Additionally, the computer may also have additional features/functionality. For example, computer 20 may also include additional storage (removable and/or non-removable) including, but not limited to, magnetic or optical disks or tape. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 20. Any such computer storage media may be part of computer 20.

Computer 20 may also contain communications connections that allow the device to communicate with other devices. A communication connection is an example of a communication medium. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. The term computer readable media as used herein includes both storage media and communication media.

Computer 20 may also have input devices such as a keyboard, mouse, pen, voice input device, touch input device, etc. Output devices such as a display 48, speakers, a printer, etc. may also be included. All these devices are well known in the art and need not be discussed at length here.

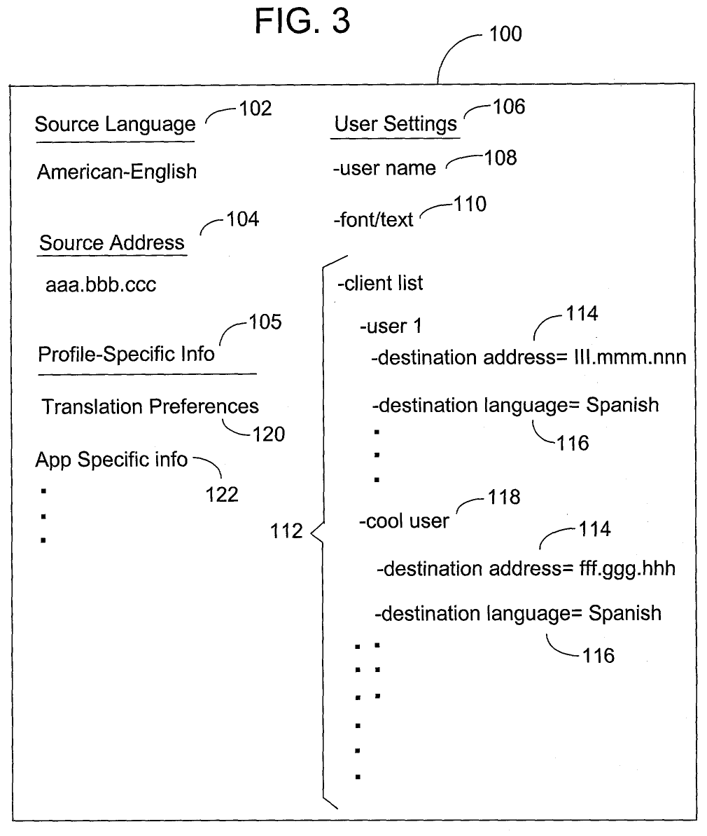

In an embodiment of the invention, each user has a corresponding user profile 100, as illustrated in FIG. 3. The user profile 100 is a data structure containing data that is descriptive of the preferences and unique settings for a particular user of a device that is to be engaged in an instant messaging session. Information stored within the profile includes, but is not limited to, a source language 102 to be used for composing messages, a source address 104 of the device, profile-specific settings 105, and user settings 106. Profile-specific settings include any other information useful for establishing and facilitating a multilingual communication session, including translation preference information 120 (e.g., destination language, locality, or geographic settings), or information pertaining to the instant messaging application itself 122. User settings 106, which is information unique to the user of the instant messaging application, can include a username 108 for identifying the user, font and text preferences 110, and a list 112 of other users (e.g., a buddy list) capable of engaging in a instant messaging session. For each user indicated in the client list 112, the associated destination address 114 and destination language 116 of that user is stored. The user of the source device can select another user to communicate with during the session, and the source device automatically retrieves or detects the settings for the other user.

To facilitate the instant messaging session, information included in the user profile 100 is exchanged between devices during session initiation. For example, if the user of the source device selects “cool user” 118 from a displayed list of users, the source device send its user profile information 100 to cool user's corresponding destination address, the location of the destination device. In exchange, cool user may send its user profile information to the source address 104 to be received by the source device, and subsequently relayed to the instant messaging application. Upon receiving this information, and establishing the appropriate handshakes (well known in the art), a session is set up between the two devices. Optionally, the user of the source device can establish a session with “user 1”, and any other users simultaneously according to the same process, thereby creating a multi-user session. By exchanging user profile information, the settings and characteristics of each device involved in the session are known to each device involved in the communication. Thus, the user of the source device knows the language preferred by the user of the destination device and the destination device knows the language of the user of the source device.

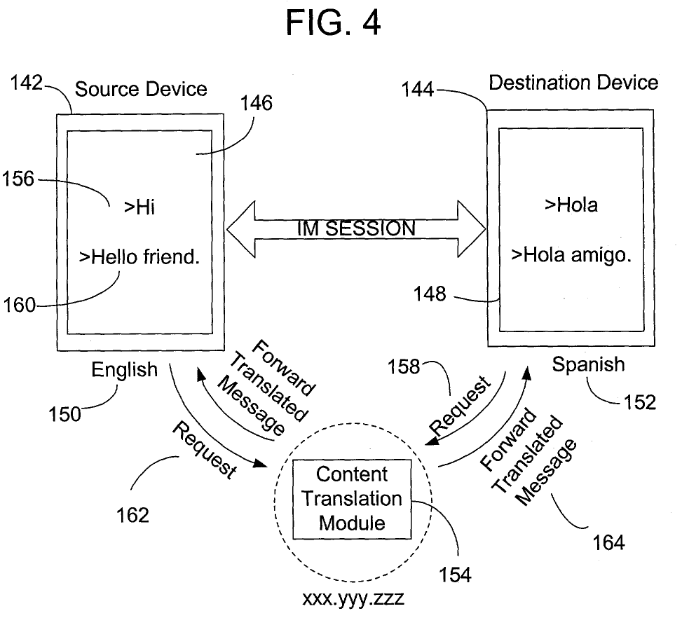

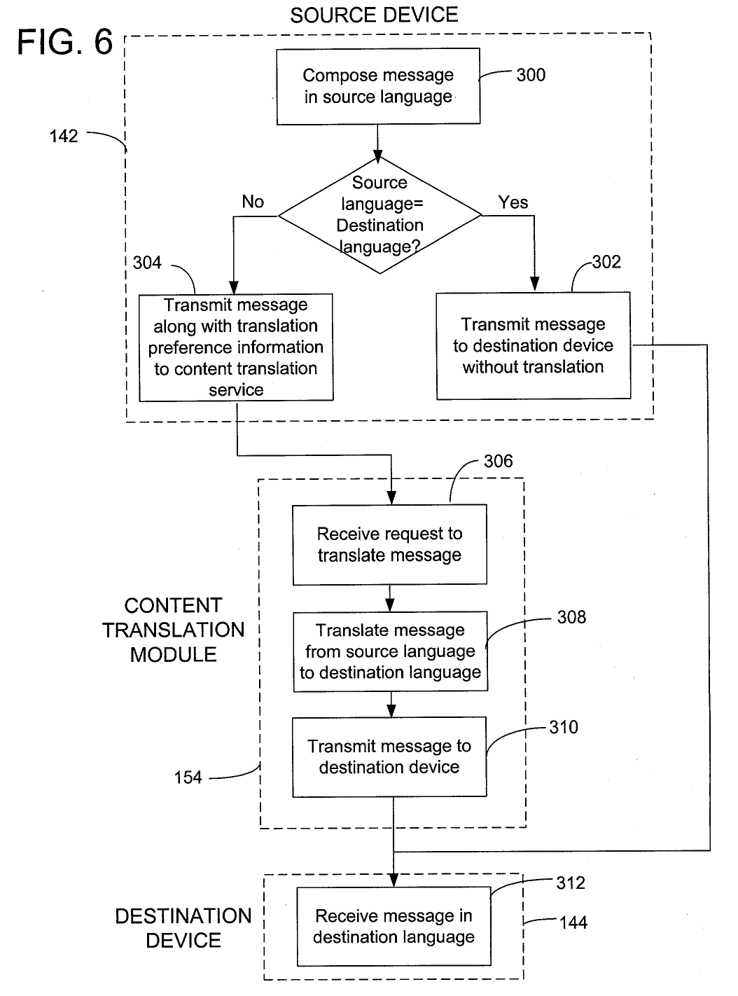

Referring now to FIG. 4 and the flowchart of FIG. 6, an example of an instant messaging session taking place between users who speak different languages in accordance with an embodiment of the invention will now be described. In this example, a user whose language is English operates a source device 142, while a user whose language is Spanish operates a destination device 144. So, in this example, the “source” language is English while the “destination” language is Spanish. The source device 142 executes an instant messaging program 146 while the destination device executes an instant messaging application 148. Both the source and destination devices, having exchanged user profile information 100, are aware of each other's language. As such, the source device 142 is able to detect the destination device user's preference for Spanish, and the destination device 144 is able to detect the source device user's preference for English. Messages are composed users of each respective device by inputting them into the instant messaging application via a keyboard, or by some other data entry means (e.g., voice-to-text software). In FIG. 4, the user of the source device 142 composes a message 156 containing the text “Hi” and then prepares the message for transmission to the destination device 144 (event 300 of FIG. 6). When the source language is equivalent to the destination language, the message is transmitted directly to the destination device without translation (event 302). However, when the destination language 152 differs from the source language 150, as illustrated, the instant messaging application 146 on the source device 142 transmits a request 162 to a content translation module to translate the message into the destination language.

The content translation module 154 is a language translation tool, generally implemented as a Dynamic Link Library (*.dll), executable application (*.exe), program module, or any other computer-executable component having routines and algorithms for performing language translation. In the embodiment, the content translation module 154 operates upon on one or more network computers, such as in a server farm or network cluster configuration. Operating singularly or in tandem, the one or more computers equipped with the content translation module 154 receive requests from the source device 142 to convert messages from the source language to the destination language (event 306). Requests messages 162 are sent using packets conforming to a common Internet protocol, such as Hypertext Transfer Protocol (HTTP) GET or POST packets (event 304). These packets include data pertaining to the original message 156 as composed in the source language 150, and one or more translation preferences 120. Translation preferences 120 contained within the user profile 100 specify, among other things, the network location of the one or more computers executing the content translation module 154, the destination language 152 the message is to be translated into, and the method of translation to be performed (e.g., rich translation, general translation, etc.). Also specified in the packets is the destination address that the message is to be transmitted to, which is the address corresponding to the network location of the destination device 144.

Upon receiving the request 162 from the source device 142, and ultimately the message composed in the source language, the content translation module 154 translates the message into the destination language 152 (event 308). Once the translation is complete, the content translation module 154 forwards the translated version of the original message to the specified destination address of the destination device (event 310). Because the original message 156 is translated prior to delivery, the user of the instant messaging application 148 receives the message and displays “Hola” on a user interface at the destination device 144 (event 312). The user of the source device 142 is therefore able to communicate in real-time with the user of the destination device as if the user of the source device were fluent in Spanish.

Referring again to FIG. 4, the content translation module 154 is shown as being at a network address xxx.yyy.zzz, and located at a location separate from that of the source device 142 and destination device 144. However, the invention is not limited to this configuration. Those skilled in the art will appreciate that the content translation module 154 may be located within the same network as the source or destination device, such as within an intranet or network cluster having the same domain in or network location as the source and destination devices. FIG. 3 provides only one example of a network configuration suitable for practicing the invention. Any network configuration that allows for the operation of the content translation module 154 is within the scope of the invention. Furthermore, any means by which messages can be translated dynamically—interactively during the session—and without extra effort on the part of the user, is within the scope of the invention.

The procedure described above is performed in such a way as to minimize disruption of the communication session between the source and destination devices. For example, the session between the source device 142 and destination device 144 is maintained even though the message 156 is translated and forwarded to the destination address by the content translation module 154 directly. Additionally, the destination device 144 communicates with the source device 142 (e.g., responding to the translated 164 message received ) according to the same process. Thus, the user of the destination device 144 composes a message according to the user's own language, which the instant messaging application inserts into a request message 158 and sends to the content translation module 154. The content translation module 154 then translates the message into the language of the user of the source device 142 and subsequently transmits the message to the source device 142. The result is a response message 160 received by the source device 142 in English, which again, results in multilingual communication between the users.

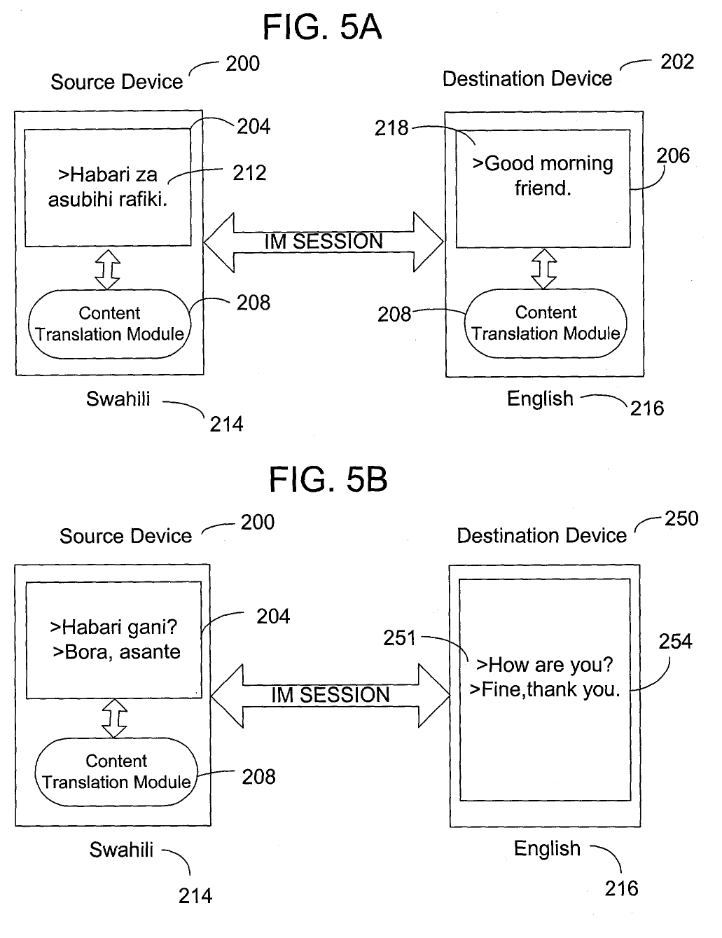

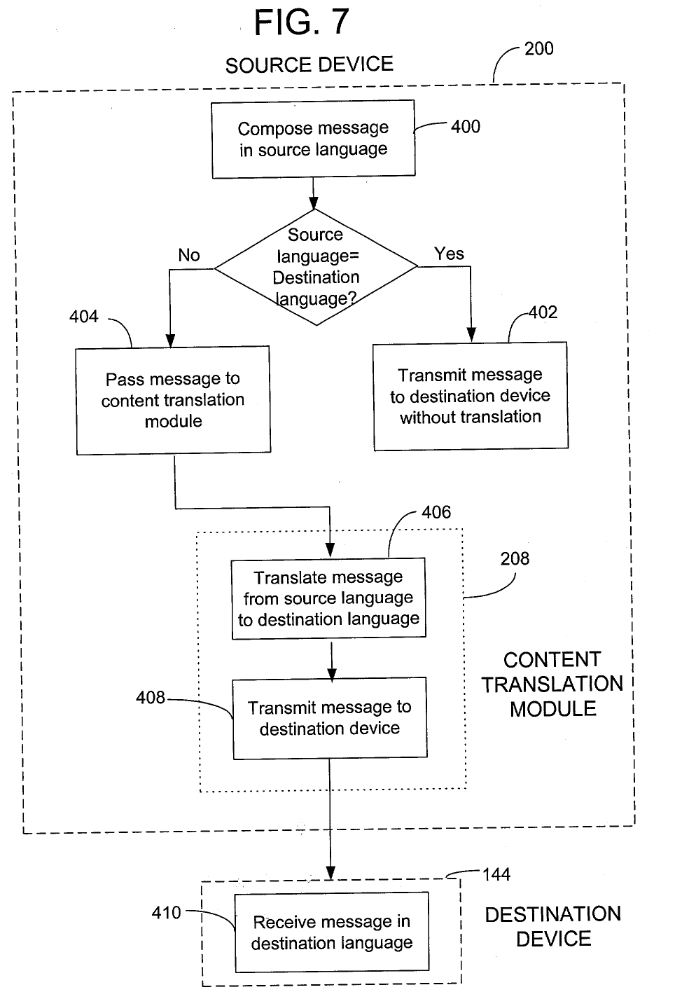

With respect now to FIGS. 5a, 5b, and the flowchart of FIG. 7, an instant messaging session 210 taking place between a source device 200 and a destination device 202 in accordance with another embodiment of the invention will be described.

As illustrated, the user of the source device 200 communicates in Swahili, while the user of the destination device 202 communicates in English. Each of the devices executes a respective instant messaging application or service (e.g., MSN Messenger, Yahoo) 204 and 206 to facilitate the communication, and both devices are equipped with a content translation module 208. The content translation module 208 resides on each of the devices and translates information from a source language to a destination language. The instant messaging application executing on each respective device can communicate with the content translation module 208 by executing operating system routines, API calls, or any other system requests in order to facilitate multilingual communication.

During the communication session between the devices, the user of the instant messaging application 204 operating on the source device 200 composes a message 212 according to the source language 214 (event 400 of FIG. 7) to be transmitted to the destination device 202. When the source language 214 is equivalent to the destination language 216, the message is transmitted directly to the destination device without translation (event 402). However, when the destination language differs from the source language, the message is passed to the content translation module 208 for translation (event 404). The translation is performed using the translation preference information 120 (FIG. 3) exchanged by each of the devices during the initiation of the session. The content translation module 208 detects the preferences indicated in the user profile 100, converts the message to the destination language (event 406), and then transmits the newly translated message to the destination address (event 408). Because the message is translated prior to delivery, the user of the instant messaging application 206 receives the message 218 in English (event 410), as if it were originally composed as such.

In FIG. 5b, the source device 200 is shown in communication with a destination device 250 having a different configuration than the destination device 202 of FIG. 5a. In this case, the destination device 250 executes an instant messaging application 254, but is not equipped with a content translation module 208 like the source device 200. Under these conditions, the destination device 250 is able to receive instant messages from the source device (translated from Swahili to English), but cannot instantly translate outgoing messages in response (translated from English to Swahili). For example, in response to the “How are you?” message 251 received from the source device 200, a message of “Fine, thank you” 254 is composed by the English speaking user. This message is then transmitted without translation, and received by the source device in English form. In accordance with the invention, however, the content translation module 208 operating on the source device 200 detects the language (English) used to compose the message, and then translates it into the source language of the user of the source device 200 (Swahili). Once the message is translated, it is passed to the instant messaging application 204. By converting the message prior to it being received by the instant messaging application 204, multilingual communication is supported even without each device being equipped with a content translation module 208.

Those skilled in the art will appreciate that the latter embodiment of the invention helps eliminate the need for each device involved in the session to have translation capabilities. Rather, only one or more devices need practice the invention in order to engage in multilingual communication. When messages are received, the content translation module detects the preferred language of the source and destination users using information obtained from the user profiles 100 exchanged between the devices. This includes the translation preferences 120 (FIG. 3), the specified destination language (the source language of the sending device), etc. Alternatively, the content translation module detects the language the message is composed in by analyzing the syntax and structure of the message such as with standard language translation algorithms and routines. Any means by which the language used to compose a message is detected or identified is within the scope of the invention.

Overall, the invention helps users of different languages to engage in instant messaging communication without compromising the real-time experience. By establishing a user profile 100 to indicate the source language and translation preference information, the session between devices can be modified and controlled to support multilingual communication. As described herein, the user profile 100 is not specific to any particular instant messaging application, and can store information beyond that shown in the illustrated embodiment of FIG. 3. For example, the translation preferences 120 or application specific information 122 specified by the user profile 100 are not the sole criterion for affecting the interaction between communicating devices. Indeed, any information can be included in the user profile 100 to affect, alter, or modify the interaction between devices (e.g., translation methods), including information about the network in which a device is located, or other information pertaining to the device.

Another aspect of the invention is that translated messages may be forwarded directly to the destination device upon translation. This is in contrast to some conventional systems, where messages are first translated, then forwarded back to the instant messaging application for transmittal. The latter impedes the real-time communication experience because more effort and time is required of the user during the communication. Furthermore, transmitting the same message to multiple users of varying languages is extremely inconvenient according to conventional methods, as a separate translation must be performed for each destination language. In other words, destination devices cannot actually receive messages instantly, but rather according to the order in which the translated version was sent. Various embodiments of the present invention, however, allow translation to be provided dynamically regardless of the number of users involved, and without extra effort on the part of the instant messaging application users.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

We claim:

1. A method for translating instant messages exchanged between two or more devices over a network by one or more users that communicate in different languages, the method comprising:
establishing a user profile indicating at least one user language and one or more translation preferences of the one or more users;
receiving a message as input composed by at least one of the users according to the user language;
translating the message from the user language to at least one different language corresponding to the one or more translation preferences; and
transmitting the message in translated form to at least one of the two or more devices.

2. The method of claim 1 wherein the step of establishing includes exchanging a user profile created by the one or more users between the two or more devices.

3. The method of claim 2 wherein the step of exchanging includes storing information associated with the user profile by each of the two or more devices.

4. The method of claim 3 wherein the information includes the one or more translation preferences.

5. The method of claim 1 wherein the step of receiving includes inputting the message into a real-time communication service residing on the two or more devices.

6. The method of claim 1 wherein the step of receiving further includes sending a request to a content translation module to translate the message from the user language to at least one different language.

7. The method of claim 6 wherein the content translation module is located at a network address corresponding to the one or more translation preferences.

8. The method of claim 7 wherein the network address is shared amongst a plurality of devices operating in a distributed networking environment.

9. The method of claim 7 wherein the network address corresponds to a single device.

10. The method of claim 1 wherein the step of transmitting includes sending the message composed in at least one different language to one or more destination addresses.

11. The method of claim 8 wherein the destination addresses correspond to the one or more translation preferences.

12. A computer-readable medium having computer-executable instructions for performing the steps recited in claim 1.

13. A system for providing real-time communication over a network between two or more devices to support multiple languages, the system comprising:
at least one source device coupled to the network for transmitting a message composed according to a source language;
a content translation module having instructions for translating the message into a destination language; and
at least one destination device coupled to the network for receiving the message from the content translation module.

14. The system of claim 13 wherein the at least one source device further comprises: a real-time communication service for receiving a message as input composed according to the source language, the message being composed by a user of the source device.

15. The system of claim 13 wherein the at least one source device transmits a user profile to the at least one destination device.

16. The system of claim 15 wherein the user profile indicates the source language and one or more translation preferences.

17. The system of claim 13 wherein the content translation module is located at a network address corresponding to the one or more translation preferences.

18. The system of claim 17 wherein the network address is shared amongst a plurality of devices operating in a distributed networking environment.

19. The system of claim 17 wherein the network address corresponds to a single device.

20. The system of claim 13 wherein the content translation module resides on the at least one source device.

21. The system of claim 13 wherein the content translation module resides on the at least one destination device.

22. The system of claim 13 wherein the at least one destination device further comprises: a real-time communication service for receiving a message as input composed according to the destination language, the message being composed by a user of the destination device.

23. The system of claim 13 wherein the at least one destination device is located at a network address corresponding to the one or more translation preferences.

24. The system of claim 13 wherein the at least one destination device transmits a user profile to the at least one source device.

25. The system of claim 15 wherein the user profile indicates the destination language and one or more translation preferences.

26. A method for translating instant messages exchanged between two or more devices over a network by one or more users that communicate in different languages, the method comprising:
receiving a message as input composed by at least one of the users according to a user language;
translating the message from the user language to at least one different language corresponding to one or more translation preferences; and
transmitting the message in translated form to at least one of the two or more devices.

27. The method of claim 26 wherein the step of receiving includes inputting the message into a real-time communication service residing on the two or more devices.

28. The method of claim 26 wherein the step of receiving further includes sending a request to a content translation module to translate the message from the user language to at least one different language.

29. The method of claim 26 wherein the step of transmitting includes sending the message in translated from to one or more destination addresses.

30. The method of claim 29 wherein the destination addresses correspond to the one or more translation preferences indicated by the at least one of the two or more devices.

31. A computer-readable medium having computer-executable instructions for performing the steps recited in claim 26.

32. A system for providing real-time communication over a network between two or more devices to support multiple languages, the system comprising:
means for receiving a message composed by a user of a first device, the message being composed in a language familiar to the user;
means for detecting the language used to compose the message; and
means for translating the message into a language familiar to a user of a second device.

33. The system of claim 32 further comprising:
means for transmitting the message in translated form to a real-time communication device operating on the second device; and
means for displaying the message in translated form to the user of the second device.

34. The system of claim 32 wherein said means for detecting comprises analyzing one or more translation preferences associated with the user of the first device.

35. The system of claim 34 wherein said means for detecting comprises analyzing the structure and syntax of the message according to a language algorithm.

36. A system for providing real-time communication over a network between two or more devices to support multiple languages, the system comprising:
means for composing a message according to a language familiar to the user of a first device;
means for translating the message into a language familiar to a user of a second device; and
means for transmitting the message to the user of the second device.
